(19) United States
(12) Patent Application Publication
(10) Pub. No.: US 2026/0323391 A1
(43) Pub. Date: Oct. 15, 2026

(54) TECHNIQUES FOR ENERGY AWARE DISTRIBUTED RELAYING

(71) Applicant: QUALCOMM Incorporated, San Diego, CA (US)

(72) Inventors: Sourjya DUTTA, Jersey City, NJ (US); Navid ABEDINI, Basking Ridge, NJ (US); Kapil GULATI, Belle Mead, NJ (US); Junyi LI, Greentown, PA (US)

(21) Appl. No.: 19/175,868

(22) Filed: Apr. 10, 2025

(51) Int. Cl. H04W 28/08; H04W 52/02; H04W 88/04

(52) U.S. Cl. CPC H04W 28/0917; H04W 52/0216; H04W 88/04

(57) ABSTRACT

Example implementations include a relay node for wireless communication systems. In one implementation, the relay node may identify buffer status information including a current buffer state and a future buffer state associated with a forwarding link with a peer node. The relay node may further transmit, to one of the peer node or another node, an indication including one or both of the current buffer state and the future buffer state for energy aware traffic routing. In another implementation, a relay node identify a current energy usage and an additional energy usage associated with a forwarding link with a peer node, wherein the additional energy usage is further associated with traffic information. The relay node may further transmit, to one of the peer node or another node, an indication including one or both of the current energy usage and the additional energy usage for energy aware traffic routing.

### TECHNICAL FIELD

Aspects of the present disclosure relate generally to wireless communication systems, and more particularly, to techniques for energy aware distributed relaying.

### DESCRIPTION OF RELATED TECHNOLOGY

Wireless communication systems are widely deployed to provide various types of communication content such as voice, video, packet data, messaging, broadcast, and so on. These systems may be multiple-access systems capable of supporting communication with multiple users by sharing the available system resources (e.g., time, frequency, and power). Examples of such multiple-access systems include code-division multiple access (CDMA) systems, time-division multiple access (TDMA) systems, frequency-division multiple access (FDMA) systems, and orthogonal frequency-division multiple access (OFDMA) systems, and single-carrier frequency division multiple access (SC-FDMA) systems.

These multiple access technologies have been adopted in various telecommunication standards to provide a common protocol that enables different wireless devices to communicate on a municipal, national, regional, and even global level. For example, a fifth generation (5G) wireless communications technology (which can be referred to as NR) is envisaged to expand and support diverse usage scenarios and applications with respect to current mobile network generations. In an aspect, 5G communications technology can include: enhanced mobile broadband addressing human-centric use cases for access to multimedia content, services and data; ultra-reliable-low latency communications (URLLC) with certain specifications for latency and reliability; and massive machine type communications, which can allow a very large number of connected devices and transmission of a relatively low volume of non-delay-sensitive information.

For example, the existing New Radio (NR) framework may support multiple relays or hops for increased communication efficiency, i.e., higher throughput, lower latency, and better coverage. However, with more hops come increased implementation complexity at least with respect to power and/or resource usage. Thus, improvements in wireless communication with respect to energy usage at relay devices may be desired.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

An example aspect includes a method of wireless communications. The method may include identifying a current energy usage and an additional energy usage associated with a forwarding link with a peer node, wherein the additional energy usage is further associated with traffic information. The method may include transmitting, to one of the peer node or another node, an indication including one or both of the current energy usage and the additional energy usage for energy aware traffic routing.

Another example aspect includes a relay node for wireless communications comprising a transceiver having a plurality of antennas, one or more memories, and one or more processors coupled to at least one of the one or more memories. The one or more processors may be configured to identify a current energy usage and an additional energy usage associated with a forwarding link with a peer node, wherein the additional energy usage is further associated with traffic information. The one or more processors may be configured to transmit, to one of the peer node or another node, an indication including one or both of the current energy usage and the additional energy usage for energy aware traffic routing.

Another example aspect includes an apparatus for wireless communications at a UE, comprising means for identifying a current energy usage and an additional energy usage associated with a forwarding link with a peer node, wherein the additional energy usage is further associated with traffic information. The apparatus may further include means for transmitting, to one of the peer node or another node, an indication including one or both of the current energy usage and the additional energy usage for energy aware traffic routing.

Another example aspect includes a computer-readable medium comprising stored instructions for wireless communications, the instructions are executable by one or more processors, individually or in combination, to identify a current energy usage and an additional energy usage associated with a forwarding link with a peer node, wherein the additional energy usage is further associated with traffic information. The computer-readable medium further comprises instructions that are executable by one or more processors, individually or in combination, to transmit, to one of the peer node or another node, an indication including one or both of the current energy usage and the additional energy usage for energy aware traffic routing.

An example aspect includes a method of wireless communications. The method may include identifying buffer status information including a current buffer state and a future buffer state associated with a forwarding link with a peer node. The method may further include transmitting, to one of the peer node or another node, an indication including one or both of the current buffer state and the future buffer state for energy aware traffic routing.

Another example aspect includes a relay node for wireless communications comprising a transceiver having a plurality of antennas, one or more memories, and one or more processors coupled to at least one of the one or more memories. The one or more processors may be configured to identify buffer status information including a current buffer state and a future buffer state associated with a forwarding link with a peer node. The one or more processors may be configured to transmit, to one of the peer node or another node, an indication including one or both of the current buffer state and the future buffer state for energy aware traffic routing.

Another example aspect includes an apparatus for wireless communications. The apparatus may further include means for identifying buffer status information including a current buffer state and a future buffer state associated with a forwarding link with a peer node. The apparatus may further include means for transmitting, to one of the peer node or another node, an indication including one or both of the current buffer state and the future buffer state for energy aware traffic routing.

Another example aspect includes a computer-readable medium comprise ng stored instructions for wireless communications, the instructions are executable by one or more processors, individually or in combination, to identify buffer status information including a current buffer state and a future buffer state associated with a forwarding link with a peer node. The computer-readable medium further comprises instructions that are executable by one or more processors, individually or in combination, to transmit, to one of the peer node or another node, an indication including one or both of the current buffer state and the future buffer state for energy aware traffic routing.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, and in which:

FIG. 1 illustrates an example of a wireless communication system, in accordance with various implementations of the present disclosure;

FIG. 2 is a block diagram illustrating an example of a network entity (also referred to as a base station or gNB), in accordance with various implementations of the present disclosure;

FIG. 3 is a block diagram illustrating an example of a user equipment (UE), in accordance with various implementations of the present disclosure;

FIG. 4 is a diagram illustrating an example disaggregated base station architecture, in accordance with various implementations of the present disclosure;

FIG. 5 is a conceptual diagram of a first multi-hop relay system and a second multi-hop relay system, in accordance with various implementations of the present disclosure;

FIG. 6 is a diagram of a buffer availability structure, in accordance with various implementations of the present disclosure;

FIG. 7 is a conceptual diagram of a first multi-hop network and a second multi-hop network, in accordance with various implementations of the present disclosure;

FIG. 8A is a conceptual diagram of an energy aware flow control structure, in accordance with various implementations of the present disclosure;

FIG. 8B is a conceptual diagram of a first energy routing, a second energy routing, and a third energy routing, in accordance with various implementations of the present disclosure;

FIG. 9A is a flowchart of an example of a method of wireless communications at a relay node for energy aware distributed relaying, in accordance with various implementations of the present disclosure;

FIG. 9B is a flowchart of an example of a method of wireless communications at a relay node supporting flow control, in accordance with various implementations of the present disclosure; and

FIG. 10 is a block diagram illustrating an example of a MIMO communication system including a base station and a UE, in accordance with various implementations of the present disclosure.

### DETAILED DESCRIPTION

Various aspects are now described with reference to the drawings. In the following description, for purposes of explanation, numerous specific details are set forth in order to provide a thorough understanding of one or more aspects. It may be evident, however, that such aspect(s) may be practiced without these specific details.

The described features generally relate to energy aware distributed relaying in multi-hop communication networks. Multi-hop relaying in wireless communication networks is a technique used to enhance coverage, capacity, and connectivity by utilizing intermediate nodes to relay data between the source and destination. Sidelink multi-hop relaying may refer to a communication technique where devices, such as user equipment (UE), communicate directly with each other without going through the base station (gNB). Sidelink multi-hop relaying may permit devices to forward data to other devices in a chain-like manner. That is, a device, i.e., UE, can act as a relay to pass information from one device to another, extending the communication range beyond the direct transmission distance.

By using relay nodes, wireless networks can extend coverage to areas that are difficult to reach with direct transmission, such as rural or indoor environments. Further, relays may help offload traffic from congested areas, improving overall network capacity and performance. Additionally, multi-hop relaying may provide alternative paths for data transmission, increasing the reliability and robustness of the network. However, a number of challenges may exist in multi-hop relaying. In particular, resource allocation, i.e., energy and data, may currently not be efficiently allocated across multiple devices acting as relay nodes. Hence, the present implementations provide efficient allocating resources such as power and spectrum across multiple devices.

Particular implementations of the subject matter described in this disclosure can be implemented to realize one or more of the following potential advantages. The disclosed techniques can extend coverage and improve connectivity. Further, by enabling direct communication between devices, multi-hop sidelink relaying can offload traffic from the core network, reducing congestion and improving overall network efficiency. As such, the techniques described herein may provide a flexible approach than enable a UE to improve coverage and connectivity, reduce power consumption, as well as improved buffer management.

Accordingly, the implementations set forth herein relate to a relay node for distributed relaying that optimizes system energy while performing flow control. The relay node may identify a current energy usage and an additional energy usage associated with a forwarding link with a peer node, wherein the additional energy usage is further associated with traffic information. The relay node may further transmit, to one of the peer node or another node, an indication including one or both of the current energy usage and the additional energy usage for energy aware traffic routing.

The implementations set forth herein additionally relate to a relay node that identifies buffer status information including a current buffer state and a future buffer state associated with a forwarding link with a peer node. The relay node may further transmit, to one of the peer node or another node, an indication including one or both of the current buffer state and the future buffer state for energy aware traffic routing.

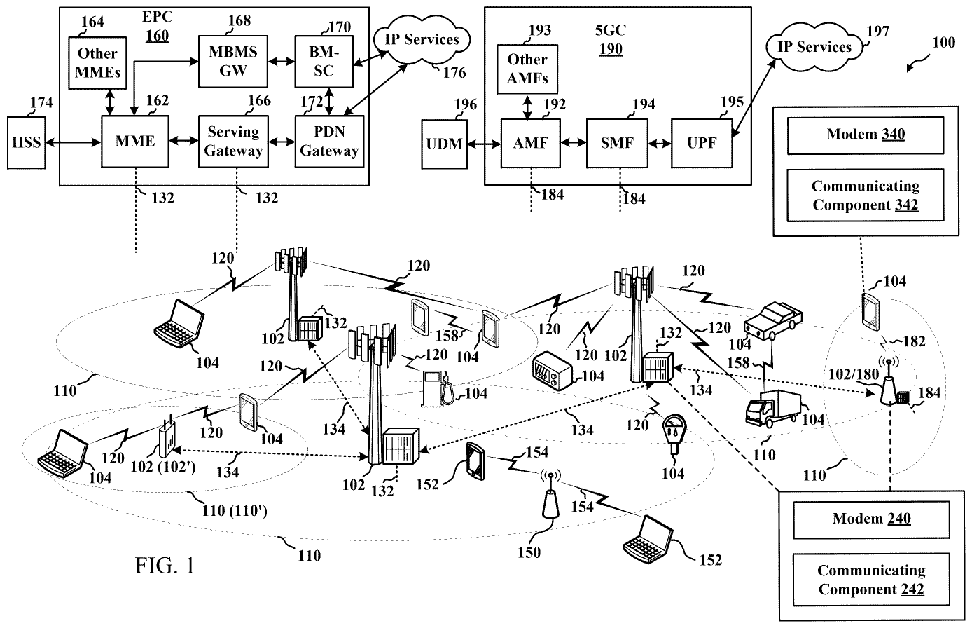

The described features will be presented in more detail below with reference to FIGS. 1-10.

As used in this application, the terms “component,” “module,” “system” and the like are intended to include a computer-related entity, such as but not limited to hardware, software, a combination of hardware and software, or software in execution. For example, a component may be, but is not limited to being, a process running on a processor, a processor, an object, an executable, a thread of execution, a program, and/or a computer. By way of illustration, both an application running on a computing device and the computing device can be a component. One or more components can reside within a process and/or thread of execution and a component can be localized on one computer and/or distributed between two or more computers. In addition, these components can execute from various computer readable media having various data structures stored thereon. The components can communicate by way of local and/or remote processes such as in accordance with a signal having one or more data packets, such as data from one component interacting with another component in a local system, distributed system, and/or across a network such as the Internet with other systems by way of the signal. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

Techniques described herein may be used for various wireless communication systems such as CDMA, TDMA, FDMA, OFDMA, SC-FDMA, and other systems. The terms “system” and “network” may often be used interchangeably. A CDMA system may implement a radio technology such as CDMA2000, Universal Terrestrial Radio Access (UTRA), etc. CDMA2000 covers IS-2000, IS-95, and IS-856 standards. IS-2000 Releases 0 and A are commonly referred to as CDMA2000 1×, 1×, etc. IS-856 (TIA-856) is commonly referred to as CDMA2000 1×EV-DO, High Rate Packet Data (HRPD), etc. UTRA includes Wideband CDMA (WCDMA) and other variants of CDMA. A TDMA system may implement a radio technology such as Global System for Mobile Communications (GSM). An OFDMA system may implement a radio technology such as Ultra Mobile Broadband (UMB), Evolved UTRA (E-UTRA), IEEE 802.11 (Wi-Fi), IEEE 802.16 (WiMAX), IEEE 802.20, Flash-OFDM™, etc. UTRA and E-UTRA are part of Universal Mobile Telecommunication System (UMTS). 3GPP Long Term Evolution (LTE) and LTE-Advanced (LTE-A) are new releases of UMTS that use E-UTRA. UTRA, E-UTRA, UMTS, LTE, LTE-A, and GSM are described in documents from an organization named “3rd Generation Partnership Project” (3GPP). CDMA2000 and UMB are described in documents from an organization named “3rd Generation Partnership Project 2” (3GPP2). The techniques described herein may be used for the systems and radio technologies mentioned above as well as other systems and radio technologies, including cellular (e.g., LTE) communications over a shared radio frequency spectrum band. The description below, however, describes an LTE/LTE-A system for purposes of example, and LTE terminology is used in much of the description below, although the techniques are applicable beyond LTE/LTE-A applications (e.g., to fifth generation (5G) NR networks or other next generation communication systems).

The following description provides examples, and is not limiting of the scope, applicability, or examples set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in other examples.

Various aspects or features will be presented in terms of systems that can include a number of devices, components, modules, and the like. It is to be understood and appreciated that the various systems can include additional devices, components, modules, etc. and/or may not include all of the devices, components, modules etc. discussed in connection with the figures. A combination of these approaches can also be used.

FIG. 1 is a diagram illustrating an example of a wireless communications system and an access network 100. The wireless communications system (also referred to as a wireless wide area network (WWAN)) can include base stations 102, UEs 104, an Evolved Packet Core (EPC) 160, and/or a 5G Core (5GC) 190. The base stations 102, which may also be referred to as network entities, may include macro cells (high power cellular base station) and/or small cells (low power cellular base station). The macro cells can include base stations. The small cells can include femtocells, picocells, and microcells. In an example, the base stations 102 may also include gNBs 180, as described further herein. The base stations 102 can be configured in a Disaggregated RAN (D-RAN) or Open RAN (O-RAN) architecture, where functionality is split between multiple units such as a central unit (CU), one or more distributed units (DUs), or a radio unit (RU). Such architectures may be configured to utilize a protocol stack that is logically split between one or more units (such as one or more CUs and one or more DUs). In some aspects, the CUs may be implemented within an edge RAN node, and in some aspects, one or more DUs may be co-located with a CU, or may be geographically distributed throughout one or multiple RAN nodes. The DUs may be implemented to communicate with one or more RUs.

In one example, some nodes such as UE 104 of the wireless communication system may have a modem 340 and communicating component 342 for virtual module formation in analog beamforming with discrete or uni-polarized antenna elements, as described herein. Though a UE 104 is shown as having the modem 340 and communicating component 342, this is one illustrative example, and substantially any node or type of node may include a modem 340 and communicating component 342 for providing corresponding functionalities described herein.

In another example, some nodes and/or network entities such as base station 102/gNB 180, may have a modem 240 and communicating component 242 for distributed relaying that optimizes system energy while performing flow control in a multi-hop network, as described herein.

Though a base station 102/gNB 180 is shown as having the modem 240 and communicating component 242, this is one illustrative example, and substantially any node or type of node may include a modem 240 and communicating component 242 for providing corresponding functionalities for supporting energy aware distributed relaying as described herein.

The base stations 102 configured for 4G LTE (which can collectively be referred to as Evolved Universal Mobile Telecommunications System (UMTS) Terrestrial Radio Access Network (E-UTRAN)) may interface with the EPC 160 through backhaul links 132 (e.g., using an S1 interface). The base stations 102 configured for 5G NR (which can collectively be referred to as Next Generation RAN (NG-RAN)) may interface with 5GC 190 through backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or 5GC 190) with each other over backhaul links 134 (e.g., using an X2 interface). The backhaul links 132, 134 and/or 184 may be wired or wireless.

The base stations 102 may wirelessly communicate with one or more UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macro cells may be referred to as a heterogeneous network. A heterogeneous network may also include Home Evolved Node Bs (eNBs) (HeNBs), which may provide service to a restricted group, which can be referred to as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (e.g., for x component carriers) used for transmission in the DL and/or the UL direction. The carriers may or may not be adjacent to each other. Allocation of carriers may be asymmetric with respect to DL and UL (e.g., more or less carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

In another example, certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, FlashLinQ, WiMedia, Bluetooth, ZigBee, Wi-Fi based on the IEEE 802.11 standard, LTE, or NR.

The wireless communications system may further include a Wi-Fi access point (AP) 150 in communication with Wi-Fi stations (STAs) 152 via communication links 154 in a 5 GHz unlicensed frequency spectrum. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same 5 GHz unlicensed frequency spectrum as used by the Wi-Fi AP 150. The small cell 102′, employing NR in an unlicensed frequency spectrum, may boost coverage to and/or increase capacity of the access network.

A base station 102, whether a small cell 102′ or a large cell (e.g., macro base station), may include an eNB, gNodeB (gNB), or other type of base station. Some base stations, such as gNB 180 may operate in a traditional sub 6 GHz spectrum, in millimeter wave (mmW) frequencies, and/or near mmW frequencies in communication with the UE 104. When the gNB 180 operates in mmW or near mmW frequencies, the gNB 180 may be referred to as an mmW base station. Extremely high frequency (EHF) is part of the RF in the electromagnetic spectrum. EHF has a range of 30 GHz to 300 GHz and a wavelength between 1 millimeter and 10 millimeters. Radio waves in the band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW/near mmW radio frequency band has extremely high path loss and a short range. The mmW base station 180 may utilize beamforming 182 with the UE 104 to compensate for the extremely high path loss and short range. A base station 102 referred to herein can include a gNB 180.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The 5GC 190 may include a AMF 192, other AMFs 193, a Session Management Function (SMF) 194, and a User Plane Function (UPF) 195. The AMF 192 may be in communication with a Unified Data Management (UDM) 196. The AMF 192 can be a control node that processes the signaling between the UEs 104 and the 5GC 190. Generally, the AMF 192 can provide QoS flow and session management. User Internet protocol (IP) packets (e.g., from one or more UEs 104) can be transferred through the UPF 195. The UPF 195 can provide UE IP address allocation for one or more UEs, as well as other functions. The UPF 195 is connected to the IP Services 197. The IP Services 197 may include the Internet, an intranet, an IP Multimedia Subsystem (IMS), a PS Streaming Service, and/or other IP services.

The base station may also be referred to as a gNB, Node B, evolved Node B (eNB), an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or 5GC 190 for a UE 104. Examples of UEs 104 include a cellular phone, a smart phone, a session initiation protocol (SIP) phone, a laptop, a personal digital assistant (PDA), a satellite radio, a positioning system (e.g., satellite, terrestrial), a multimedia device, a video device, a digital audio player (e.g., MP3 player), a camera, a game console, a tablet, a smart device, robots, drones, an industrial/manufacturing device, a wearable device (e.g., a smart watch, smart clothing, smart glasses, virtual reality goggles, a smart wristband, smart jewelry (e.g., a smart ring, a smart bracelet)), a vehicle/a vehicular device, a meter (e.g., parking meter, electric meter, gas meter, water meter, flow meter), a gas pump, a large or small kitchen appliance, a medical/healthcare device, an implant, a sensor/actuator, a display, or any other similar functioning device. Some of the UEs 104 may be referred to as IoT devices (e.g., meters, pumps, monitors, cameras, industrial/manufacturing devices, appliances, vehicles, robots, drones, etc.). Further, some of the UEs 104 may be referred to or otherwise correspond to AIoT devices IoT UEs may include MTC/enhanced MTC (eMTC, also referred to as CAT-M, Cat M1) UEs, NB-IoT (also referred to as CAT NB1) UEs, as well as other types of UEs. In the present disclosure, eMTC and NB-IoT may refer to future technologies that may evolve from or may be based on these technologies. For example, eMTC may include FeMTC (further eMTC), eFeMTC (enhanced further eMTC), mMTC (massive MTC), etc., and NB-IoT may include eNB-IoT (enhanced NB-IoT), FeNB-IoT (further enhanced NB-IoT), etc. One or both of the UE 104 or the base station 102 may corresponds to a reader device capable of or otherwise configured to communicate with one or more AIoT devices according to the present signaling architecture implementations described herein. The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

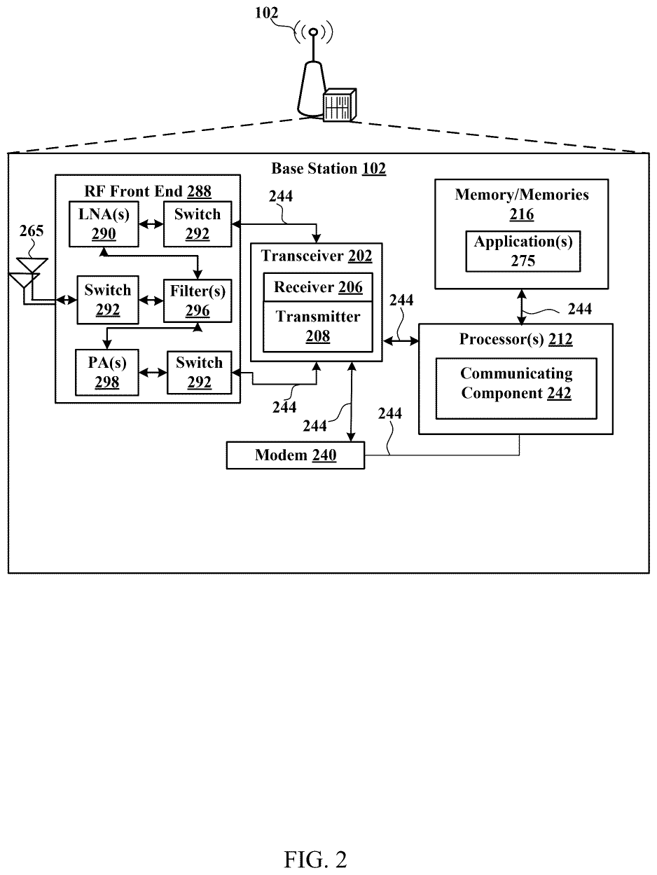

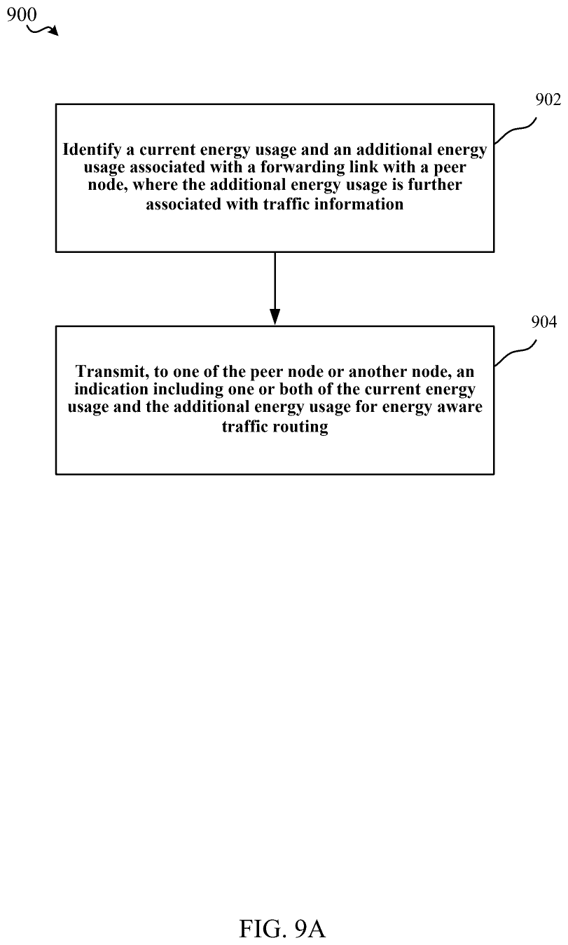

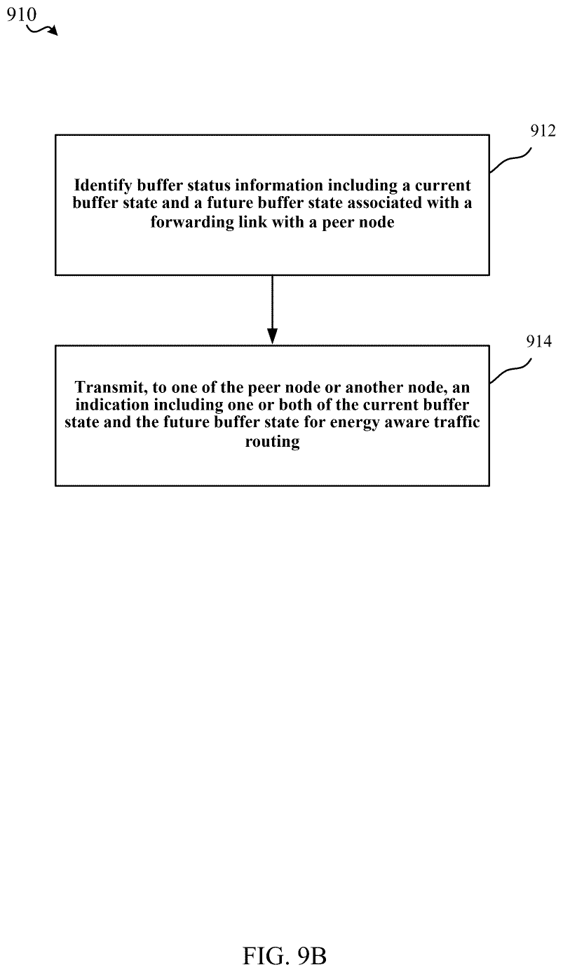

Turning now to FIGS. 2-10, aspects are depicted with reference to one or more components and one or more methods that may perform the actions or operations described herein, where aspects in dashed line may be optional. Although the operations described below in FIGS. 9A and 9B are presented in a particular order and/or as being performed by an example component, it should be understood that the ordering of the actions and the components performing the actions may be varied, depending on the implementation. Moreover, it should be understood that the following actions, functions, and/or described components may be performed by a specially-programmed processor, a processor executing specially-programmed software or computer-readable media, or by any other combination of a hardware component and/or a software component capable of performing the described actions or functions.

Referring to FIG. 2, one example of an implementation of a node or network device, such as the base station 102 (e.g., a base station 102 and/or gNB 180, as described above, which may also be referred to or otherwise correspond to a reader device in an AIoT application) may include a variety of components, some of which have already been described above and are described further herein, including components such as one or more processors 212 and memory 216 and transceiver 202 in communication via one or more buses 244, which may operate in conjunction with modem 240 and/or communicating component 242 for distributed relaying in a multi-hop network that optimizes system energy while performing flow control.

In an aspect, the one or more processors 212 can include a modem 240 and/or can be part of the modem 240 that uses one or more modem processors. Thus, the various functions related to communicating component 242 may be included in modem 240 and/or processors 212 and, in an aspect, can be executed by a single processor, while in other aspects, different ones of the functions may be executed by a combination of two or more different processors. For example, in an aspect, the one or more processors 212 may include any one or any combination of a modem processor, or a baseband processor, or a digital signal processor, or a transmit processor, or a receiver processor, or a transceiver processor associated with transceiver 202. In other aspects, some of the features of the one or more processors 212 and/or modem 240 associated with communicating component 242 may be performed by transceiver 202.

Also, memory 216 may be configured to store data used herein and/or local versions of applications 275 or communicating component 242 and/or one or more of its subcomponents being executed by at least one processor 212. Memory 216 can include any type of computer-readable medium usable by a computer or at least one processor 212, such as random access memory (RAM), read only memory (ROM), tapes, magnetic discs, optical discs, volatile memory, non-volatile memory, and any combination thereof. In an aspect, for example, memory 216 may be a non-transitory computer-readable storage medium that stores one or more computer-executable codes defining communicating component 242 and/or one or more of its subcomponents, and/or data associated therewith, when base station 102 is operating at least one processor 212 to execute communicating component 242 and/or one or more of its subcomponents.

Transceiver 202 may include at least one receiver 206 and at least one transmitter 208. Receiver 206 may include hardware and/or software executable by a processor for receiving data, the code comprising instructions and being stored in a memory (e.g., computer-readable medium). Receiver 206 may be, for example, a radio frequency (RF) receiver. In an aspect, receiver 206 may receive signals transmitted by at least one base station 102. Additionally, receiver 206 may process such received signals, and also may obtain measurements of the signals, such as, but not limited to, Ec/Io, signal-to-noise ratio (SNR), reference signal received power (RSRP), received signal strength indicator (RSSI), etc. Transmitter 208 may include hardware and/or software executable by a processor for transmitting data, the code comprising instructions and being stored in a memory (e.g., computer-readable medium). A suitable example of transmitter 208 may including, but is not limited to, an RF transmitter.

Moreover, in an aspect, base station 102 may include RF front end 288, which may operate in communication with one or more antennas 265 and transceiver 202 for receiving and transmitting radio transmissions, for example, wireless communications transmitted by at least one base station 102 or wireless transmissions transmitted by UE 104. RF front end 288 may be connected to one or more antennas 265 and can include one or more low-noise amplifiers (LNAs) 290, one or more switches 292, one or more power amplifiers (PAs) 298, and one or more filters 296 for transmitting and receiving RF signals. The antennas 265 may include one or more antennas, antenna elements, and/or antenna arrays.

In an aspect, LNA 290 can amplify a received signal at a desired output level. In an aspect, each LNA 290 may have a specified minimum and maximum gain values. In an aspect, RF front end 288 may use one or more switches 292 to select a particular LNA 290 and its specified gain value based on a desired gain value for a particular application.

Further, for example, one or more PA(s) 298 may be used by RF front end 288 to amplify a signal for an RF output at a desired output power level. In an aspect, each PA 298 may have specified minimum and maximum gain values. In an aspect, RF front end 288 may use one or more switches 292 to select a particular PA 298 and its specified gain value based on a desired gain value for a particular application.

Also, for example, one or more filters 296 can be used by RF front end 288 to filter a received signal to obtain an input RF signal. Similarly, in an aspect, for example, a respective filter 296 can be used to filter an output from a respective PA 298 to produce an output signal for transmission. In an aspect, each filter 296 can be connected to a specific LNA 290 and/or PA 298. In an aspect, RF front end 288 can use one or more switches 292 to select a transmit or receive path using a specified filter 296, LNA 290, and/or PA 298, based on a configuration as specified by transceiver 202 and/or processor 212.

As such, transceiver 202 may be configured to transmit and receive wireless signals through one or more antennas 265 via RF front end 288. In an aspect, transceiver may be tuned to operate at specified frequencies such that UE 104 can communicate with, for example, one or more base stations 102 or one or more cells associated with one or more base stations 102. In an aspect, for example, modem 240 can configure transceiver 202 to operate at a specified frequency and power level based on the UE configuration of the UE 104 and the communication protocol used by modem 240.

In an aspect, modem 240 can be a multiband-multimode modem, which can process digital data and communicate with transceiver 202 such that the digital data is sent and received using transceiver 202. In an aspect, modem 240 can be multiband and be configured to support multiple frequency bands for a specific communications protocol. In an aspect, modem 240 can be multimode and be configured to support multiple operating networks and communications protocols. In an aspect, modem 240 can control one or more components of UE 104 (e.g., RF front end 288, transceiver 202) to enable transmission and/or reception of signals from the network based on a specified modem configuration. In an aspect, the modem configuration can be based on the mode of the modem and the frequency band in use. In another aspect, the modem configuration can be based on UE configuration information associated with UE 104 as provided by the network during cell selection and/or cell reselection.

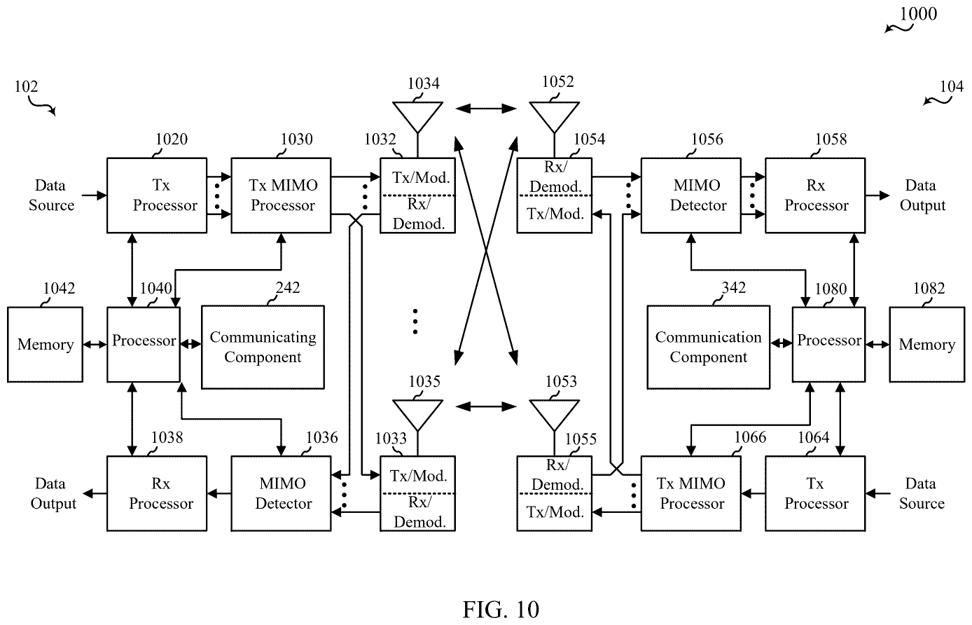

In an aspect, the processor(s) 212 may correspond to one or more of the processors described in connection with the UE in FIG. 10. Similarly, the memory 216 may correspond to the memory described in connection with the UE in FIG. 10.

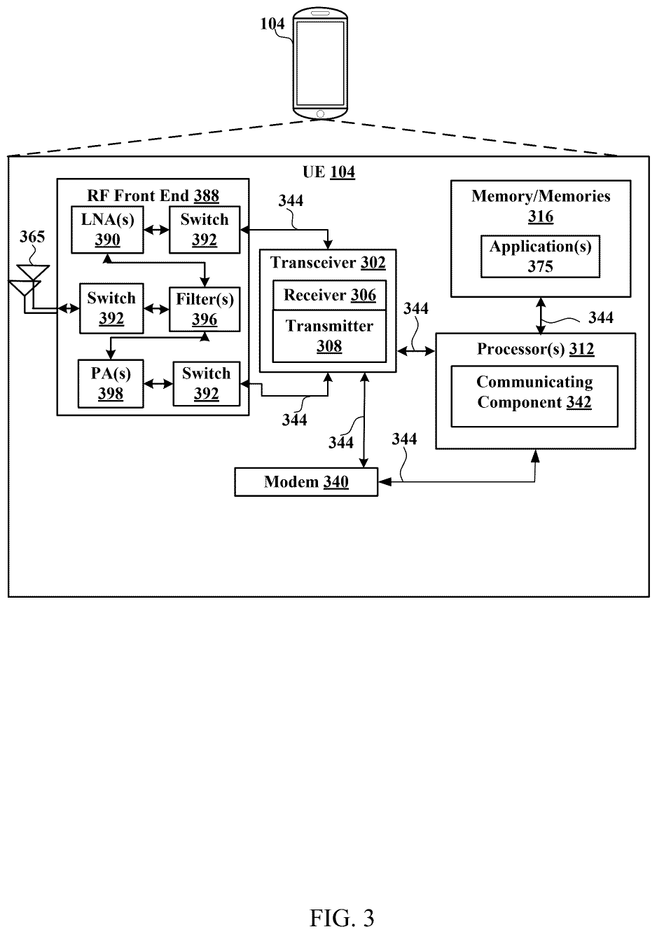

Referring to FIG. 3, one example of an implementation of UE 104. The UE 104 may include a variety of components, some of which have already been described above and are described further herein, including components such as one or more processors 312 and memory 316 and transceiver 302 in communication via one or more buses 344, which may operate in conjunction with modem 340 and/or communicating component 342 for distributed relaying in a multi-hop communication network that optimizes system energy while performing flow control to mitigate buffer overflow and link congestion.

The transceiver 302, receiver 306, transmitter 308, one or more processors 312, memory 316, applications 375, buses 344, RF front end 388, LNAs 390, switches 392, filters 396, PAs 398, and one or more antennas 365 may be the same as or similar to the corresponding components of base station 102, as described above, but configured or otherwise programmed for base station operations as opposed to base station operations.

In an aspect, the processor(s) 312 may correspond to one or more of the processors described in connection with the base station in FIG. 10. Similarly, the memory 316 may correspond to the memory described in connection with the base station in FIG. 10.

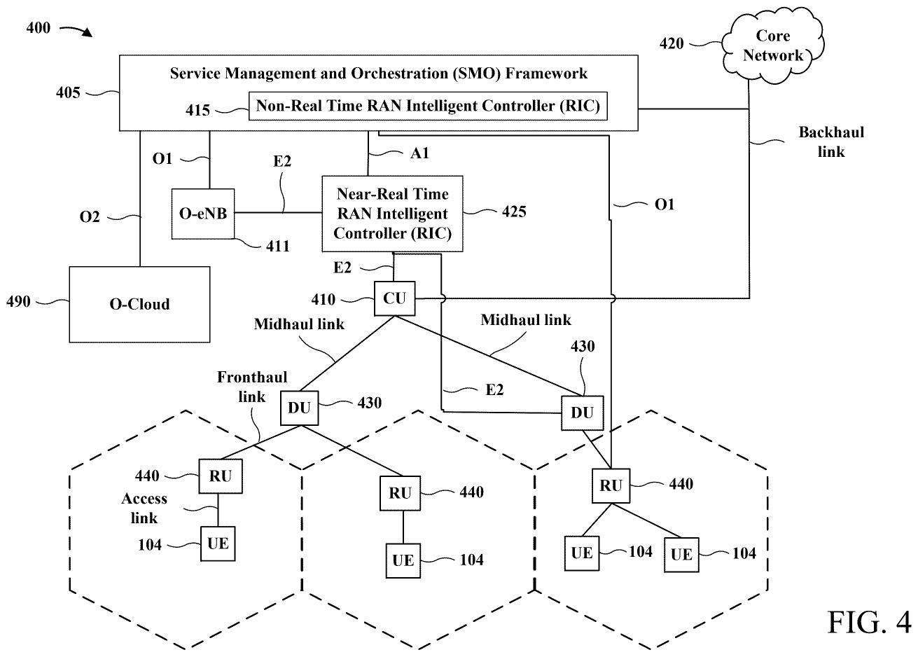

FIG. 4 is a diagram illustrating an example disaggregated base station 400 architecture. The disaggregated base station 400 may be configured for distributed relaying that optimizes system energy while performing flow control. The disaggregated base station 400 architecture may include one or more central units (CUs) 410 that can communicate directly with a core network 420 via a backhaul link, or indirectly with the core network 420 through one or more disaggregated base station units (such as a Near-Real Time (Near-RT) RAN Intelligent Controller (RIC) 425 via an E2 link, or a Non-Real Time (Non-RT) RIC 415 associated with a Service Management and Orchestration (SMO) Framework 2105, or both). A CU 410 may communicate with one or more distributed units (DUs) 430 via respective midhaul links, such as an F1 interface. The DUs 430 may communicate with one or more radio units (RUs) 440 via respective fronthaul links. The RUs 440 may communicate with respective UEs 104 via one or more radio frequency (RF) access links. In some implementations, the UE 104 may be simultaneously served by multiple RUs 440.

Each of the units, i.e., the CUS 410, the DUs 430, the RUs 440, as well as the Near-RT RICs 425, the Non-RT RICs 415 and the SMO Framework 405, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 410 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 410. The CU 410 may be configured to handle user plane functionality (i.e., Central Unit-User Plane (CU-UP)), control plane functionality (i.e., Central Unit-Control Plane (CU-CP)), or a combination thereof. In some implementations, the CU 410 can be logically split into one or more CU-UP units and one or more CU-CP units. The CU-UP unit can communicate bidirectionally with the CU-CP unit via an interface, such as the E1 interface when implemented in an O-RAN configuration. The CU 410 can be implemented to communicate with the DU 430, as necessary, for network control and signaling.

The DU 430 may correspond to a logical unit that includes one or more base station functions to control the operation of one or more RUs 440. In some aspects, the DU 430 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 430 may further host one or more low PHY layers. Each layer (or module) can be implemented with an interface configured to communicate signals with other layers (and modules) hosted by the DU 430, or with the control functions hosted by the CU 410.

Lower-layer functionality can be implemented by one or more RUs 440. In some deployments, an RU 440, controlled by a DU 430, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 440 can be implemented to handle over the air (OTA) communication with one or more UEs 104. In some implementations, real-time and non-real-time aspects of control and user plane communication with the RU(s) 440 can be controlled by the corresponding DU 430. In some scenarios, this configuration can enable the DU(s) 430 and the CU 410 to be implemented in a cloud-based RAN architecture, such as a vRAN architecture.

The SMO Framework 405 may be configured to support RAN deployment and provisioning of non-virtualized and virtualized network elements. For non-virtualized network elements, the SMO Framework 405 may be configured to support the deployment of dedicated physical resources for RAN coverage requirements which may be managed via an operations and maintenance interface (such as an O1 interface). For virtualized network elements, the SMO Framework 405 may be configured to interact with a cloud computing platform (such as an open cloud (O-Cloud) 490) to perform network element life cycle management (such as to instantiate virtualized network elements) via a cloud computing platform interface (such as an O2 interface). Such virtualized network elements can include, but are not limited to, CUs 410, DUs 430, RUs 440 and Near-RT RICs 425. In some implementations, the SMO Framework 405 can communicate with a hardware aspect of a 4G RAN, such as an open eNB (O-eNB) 411, via an O1 interface. Additionally, in some implementations, the SMO Framework 2105 can communicate directly with one or more RUs 440 via an O1 interface. The SMO Framework 405 also may include a Non-RT RIC 415 configured to support functionality of the SMO Framework 405.

The Non-RT RIC 415 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 425. The Non-RT RIC 415 may be coupled to or communicate with (such as via an A1 interface) the Near-RT RIC 425. The Near-RT RIC 425 may be configured to include a logical function that enables near-real-time control and optimization of RAN elements and resources via data collection and actions over an interface (such as via an E2 interface) connecting one or more CUs 410, one or more DUs 430, or both, as well as an O-eNB, with the Near-RT RIC 425.

In some implementations, to generate AI/ML models to be deployed in the Near-RT RIC 425, the Non-RT RIC 415 may receive parameters or external enrichment information from external servers. Such information may be utilized by the Near-RT RIC 425 and may be received at the SMO Framework 405 or the Non-RT RIC 415 from non-network data sources or from network functions. In some examples, the Non-RT RIC 415 or the Near-RT RIC 425 may be configured to tune RAN behavior or performance. For example, the Non-RT RIC 415 may monitor long-term trends and patterns for performance and employ AI/ML models to perform corrective actions through the SMO Framework 405 (such as reconfiguration via O1) or via creation of RAN management policies (such as A1 policies).

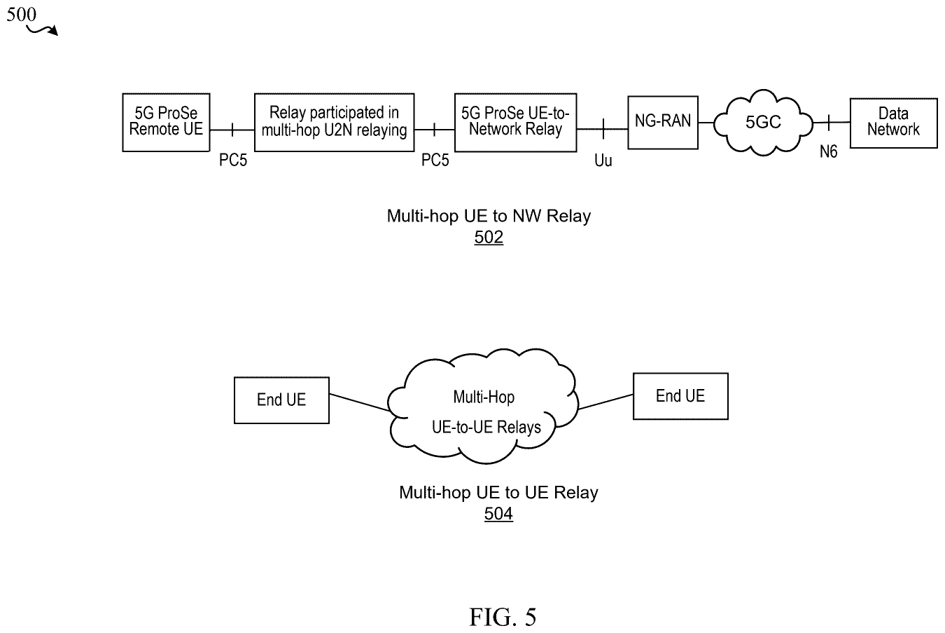

FIG. 5 is a conceptual diagram 500 of a first multi-hop relay system 502 and a second multi-hop relay system 504. Multi-hop relays can be used for relaying between multiple remote UEs and the network or between two or more remote UEs. The first multi-hop relay system 502 represents a multi-hop UE to network relay network. Multi-hop UE-to-network relay may be based on layer two (L2) or layer three (L3) relaying. The first multi-hop relay system 502 may include a 5G ProSe remote UE communicating with a relay UE participating in multi-hop user-to-network (U2N) relaying via a PC5 interface. Further, the relay UE participating in multi-hop U2N relaying may communicate with a 5G ProSe UE-to-network relay via a PC5 interface.

The 5G ProSe UE-to-network relay may communicate with a Next Generation Radio Access Network (NG-RAN) via a Uu interface, which in turn communicates with core network, i.e., 5GC and data network. The second multi-hop relay system 504 may represent a multi-hop UE to UE relay network. Multi-hop UE-to-UE relaying may be based on L3 relaying, i.e., Internet protocol (IP) based. In this network, two distinct end UEs may communicate with each other via one or more multi-hop UE-to-UE relays. Both the first multi-hop relay system 502 and the second multi-hop relay system 504 may correspond to sidelink multi-hop relaying.

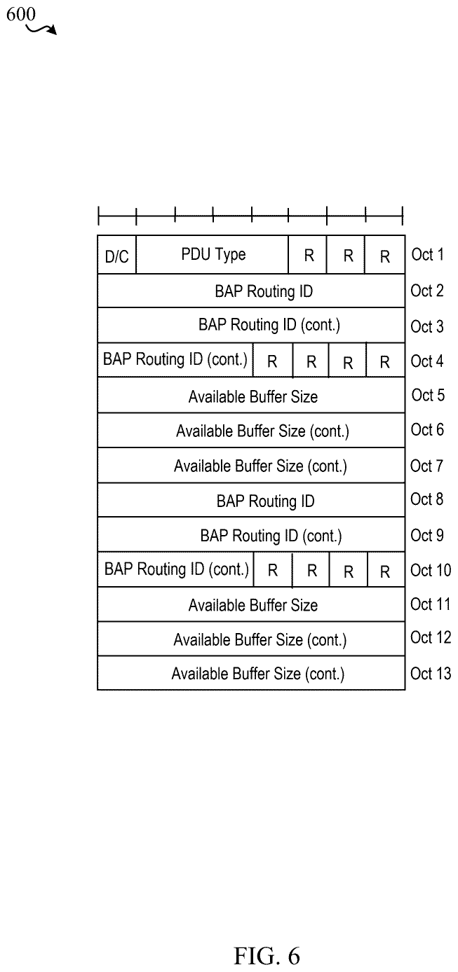

FIG. 6 is a diagram of a buffer availability structure 600. The buffer availability structure 600 may include a number of octets, each of which includes associated information for buffer availability for backhaul adaptation protocol (BAP) based flow control. Octet 1 may include the data/control (D/C) bit, which indicates whether the packet data unit (PDU) is a BAP Control PDU (value 0) or a BAP Data PDU (value 1). This bit may distinguish between control and data PDUs within the BAP.

Octets 2-4 may include the BAP Routing Identifier (ID), which may be used to identify the specific route or path that the data should take within the network. This may be beneficial for directing the data packets to the correct destination and ensuring efficient flow control within the network. The BAP Routing ID may help in managing the data flow by associating it with specific network paths, which is useful for optimizing network performance and resource allocation.

Octets 5-7 may include the Available Buffer Size. The Available Buffer Size may indicate the amount of buffer space available for data transmission. This information may be useful for managing data flow and ensuring that the network can handle the data load without congestion or data loss. By knowing the buffer size, the network can make informed decisions about data scheduling and resource allocation, optimizing overall network performance. Octets 8-10 may include BAP Routing ID. Octets 11-13 may include the Available Buffer Size.

In 5G networks, multi-hop relaying may be a strategy aimed at network densification, enhancing coverage and capacity by utilizing intermediate nodes to relay data. The backhaul in these networks is wirelessly forwarded across Integrated Access and Backhaul (IAB) nodes, facilitating efficient data transmission. Flow control within this setup may be managed by the F1 interface and the BAP. Specifically, the F1 Application Protocol (F1AP) messages may be exchanged between the gNB Distributed Unit (gNB-DU) and the gNB Central Unit (gNB-CU), or between the IAB-DU and the IAB-donor-DU, to notify about downlink congestion. BAP may provide a Layer 2 flow control mechanism through explicit buffer size indication, allowing for precise management of data flow and ensuring optimal network performance.

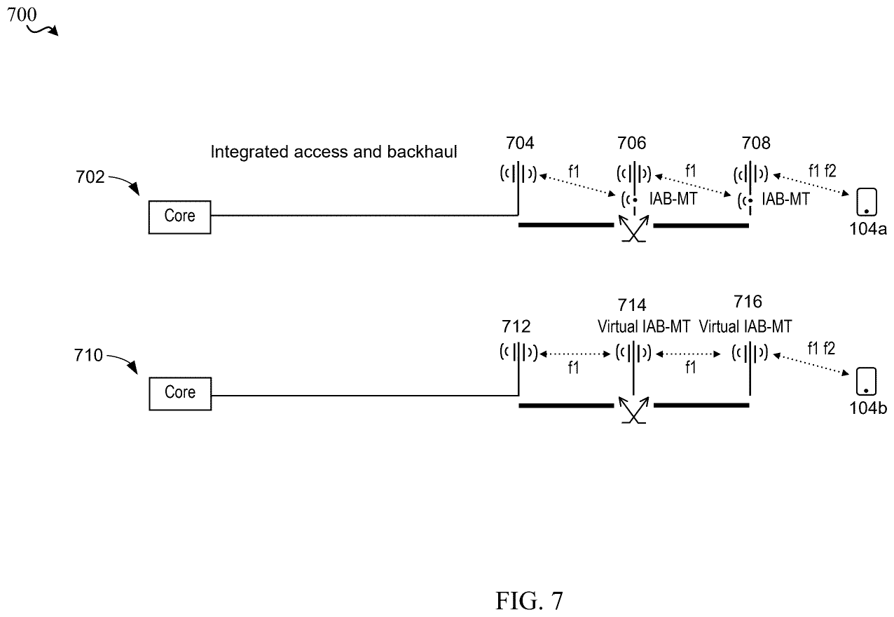

FIG. 7 is a conceptual diagram of a first multi-hop network 702 and a second multi-hop network 710. The first multi-hop network 702 may include an integrated access and backhaul end that comprises a core network. The first multi-hop network 702 may include a first IAB node 704 that communicates with a second IAB node 706 having an integrated access and backhaul-mobile termination (IAB-MT) on a first frequency. An IAB-MT may be responsible for managing the mobile traffic that is being routed through the IAB node, ensuring that data is properly terminated and processed. The second IAB node 706 may communicate with a third IAB node 708 having an IAB-MT on the first frequency. The third IAB node may communicate with a UE 104a on one or both of the first frequency or a second frequency. In this example, two of the first IAB node, the second IAB node 706, or the third IAB node may act or operate as relay nodes.

The second multi-hop network 710 may be arranged similarly to the first multi-hop network 702, but with at least two virtual IAB-MTs. Virtual IAB-MT may refer to virtualized version of the IAB-MT component. Virtualization in wireless communication networks involves creating virtual instances of network functions that can run on general-purpose hardware, rather than relying on dedicated physical equipment. This allows for greater flexibility, scalability, and resource efficiency, as multiple virtual instances can be deployed on shared hardware. Like its physical counterpart, the virtual IAB-MT may be responsible for handling mobile traffic termination within the IAB node, and may manage the routing and processing of data as it moves between the access network and the backhaul network.

The second multi-hop network 710 may include an IAB end that comprises a core network. The second multi-hop network 710 may include a first IAB node 712 that communicates with a first virtual IAB-MT node 714 on a first frequency. The first virtual IAB-MT node 714 may communicate with a second virtual IAB-MT node 716 on the first frequency. The second virtual IAB-MT node may communicate with a UE 104b on one or both of the first frequency or a second frequency. In this example, two of the first IAB node, the first virtual IAB-MT node 706, or the second IAB-MT node may act or operate as relay nodes.

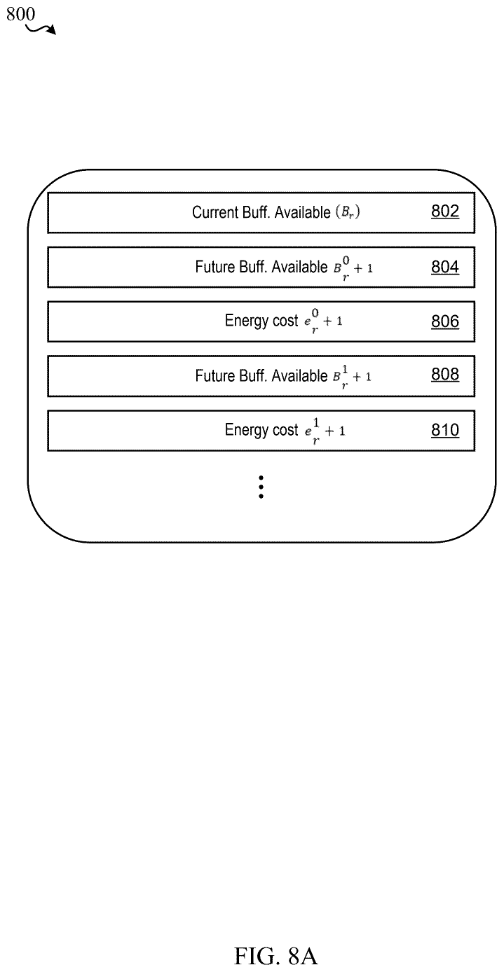

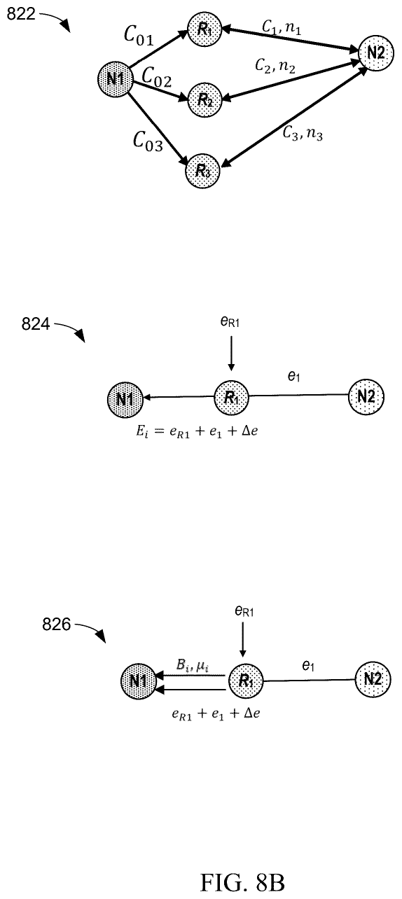

FIG. 8A is a conceptual diagram of an energy aware flow control structure 800. The energy aware flow control structure 800 may include one or more of a current buffer availability 802, a future buffer availability 804, an energy cost 806, a second future buffer availability 808, and a second energy cost 810.

In some wireless communication networks, implementing energy-aware distributed relaying arises from the desire to optimize current multi-hop data transfer methods. Sidelink multi-hop relaying may operate within a distributed architecture, where connections between sources, relays, and destinations are managed based on the sidelink transmission paradigm. This involves multi-hop UE-to-UE relaying, which may rely on established Mobile Ad Hoc Network (MANET) protocols, utilizing lower layer inputs for link quality and statistics, known as Layer 3 (L3) relaying. Additionally, multi-hop UE to Network (UE-NW) relaying may be Layer 2 (L2) based, with relay selection performed at lower layers according to the link quality of the next hop.

IAB may employ a hierarchical architecture, where the Distributed Unit (DU) at IAB nodes may manage the backhaul link between the next IAB-MT node or the UE, with flow control executed using the BAP. However, challenges may exist as neither the IAB framework nor the current sidelink multi-hop framework account for power or energy constraints of the nodes. While the IAB framework may include some buffer management mechanisms, sidelink multi-hop relays may lack provisions for managing buffer overload. Future distributed multi-hop relay networks may be designed to minimize buffer overflows and packet drops while maintaining power efficiency. This necessitates the development of mechanisms within distributed relay networks to optimize system energy and perform effective flow control, thereby avoiding issues such as buffer overflow and link congestion.

A first implementation for energy aware relaying relates to an energy cost indication, i.e., energy cost 806 and second energy cost 810. Specifically, the first implementation includes distributed relay nodes to communicate energy costs to peer nodes, facilitating energy-efficient routing decisions. A relay node may indicate its current energy cost

$$( {e}_{i}^{0} )$$

and additional energy costs associated with various traffic classes, based on joint link state and energy optimality criteria. In one aspect, the relay node, considering its current power consumption and power-saving schemes, may provide a list of additional energy costs for different traffic classes, a process which may be referred to as discovery-based energy cost sharing.

Each traffic class may specify parameters such as jitter, delay tolerance, burst length, and periodicity. For instance, a traffic class might incur no additional energy cost, indicating minimal energy expense (i.e., no additional energy expense to support the traffic class), while another might have an infinite additional energy cost, rendering it inadmissible under current relay operations. Alternatively, in another aspect, in request-based energy cost sharing, a source node can send updated traffic information to relay nodes, requesting an energy cost metric for energy-aware routing. This information may include expected traffic rates, packet sizes, burst durations, priority, and end-to-end delay requirements. The relay node, upon receiving these traffic statistics, may respond to the source UE with an updated energy cost for supporting the new or updated traffic flow.

A second implementation of energy aware relaying (i.e., energy cost 806 and second energy cost 810) may include a relay node that periodically, or when there is a change in energy consumption, communicates its updated energy cost to other nodes. This approach may be intended to facilitate route changes if a more energy-efficient path becomes available. For instance, changes in energy cost may occur due to the establishment, teardown, or rerouting of traffic for one or more sessions, or as a result of modifications in power-saving mechanisms negotiated between nodes at the PHY/MAC layers.

A third implementation of energy aware relaying (i.e., energy cost 806 and second energy cost 810) relates to energy costs influenced by a Discontinuous Reception (DRX) schedule or other power-saving mechanisms employed at the node. Updates to energy costs or additional energy costs may arise from changes in the DRX or power-saving schedule.

A fourth implementation of energy aware relaying (i.e., energy cost 806 and second energy cost 810) provides a relay node that may indicate not only its own energy cost but also the energy cost (and additional energy cost) for the path to one or more destination nodes. In this scenario, energy costs may be used additively at a node, along with link quality, to assess the total energy costs of a node. These energy costs, combined with link costs, can be utilized in a weighted manner to determine the most energy-efficient path

$$( ( e . g . , {min}_{\{ i ∈ paths \}} ( α {D}_{i} + β {E}_{i} ) ,$$

Dᵢ:=delay of path i, Eᵢ:=energy cost of path i, paths:=set of all paths to a dest node).

A fifth implementation relates to energy aware flow control, i.e., current buffer availability 802, a future buffer availability 804, and a second future buffer availability 808. The fifth implementation relates to a relay node may communicate its current and/or predicted future buffer state to its peers using various parameters. A relay node may share its current buffer status or availability (Bᵣ) along with the forward link service rate (μᵣ). This information may allow peer nodes to e82stimate future buffer status based on the current buffer status and service rate, using calculations such as Bᵣ−k*μᵣ+k*E(λ), where the arrival rate (λ) may be estimated at the source node or explicitly indicated based on energy cost considerations.

In some scenarios, the current buffer availability 802 may be accompanied by a predicted future buffer status or availability 804 instead of the service rate. Alternatively, the current buffer availability 802 may be provided alongside a list of future predicted buffer statuses, i.e., 804 and 808, each associated with predicted energy costs, i.e., 806 and 810. For example, an energy cost related to buffer availability may be based on the increased service rate required to prevent buffer overflow or bloating, potentially involving the reduction or deactivation of power-saving mechanisms. In certain examples, an energy cost associated with a buffer state might be infinite, indicating that the buffer state, if reached, is unserviceable and will result in errors or losses. Additionally, buffer status information may be supplemented with a maximum bit rate indication, where the maximum bit rate(s) indicated may be associated with a predicted buffer status and/or a predicted energy cost.

FIG. 8B is a conceptual diagram of a first energy routing 822, a second energy routing 824, and a third energy routing 826. The first energy routing 822 includes a route selection at node N1 for reaching node N2. The first energy routing 822 may include a cost for the paths: C₀₁+C₁, C₀₂+C₂, . . . (i.e., lower cost the better). The path may be selected by

$${min}_{\{ i , {n}_{i} < {n}_{0} \}} ( {C}_{0 i} + {C}_{i} ) .$$

In this aspect, the link quality may be optimal but does not consider energy consumption or buffer constraints at the next or intermediate nodes.

The second energy routing 824 may also correspond to an energy aware routing example. The cost for the paths may be represented as C₀₁+C₁, C₀₂+C₂. The energy consumption for a given path (E) may be the sum of the current energy of the path through the node and a differential energy consumption for the traffic class. The path may be selected according to

$${min}_{\{ i , {n}_{i} < {n}_{0} \}} {λ}_{1} ( {C}_{0 i} + {C}_{i} ) + {λ}_{2} {E}_{i} .$$

The second energy routing 824 may be optimal in terms of link quality and path energy consumption

The third energy routing 826 may be a further energy aware routing example with flow control. The cost for the paths may be represented as C₀₁+C₁, C₀₂+C₂. The energy consumption for a given path may be represented as (E;). Further, the buffer availability for node may be represented as Bᵢ−kμᵢ where μᵢ is the service rate. The path may be selected according to

$${min}_{\{ i , {n}_{i} < {n}_{0} \}} [ {λ}_{1} ( {C}_{0 i} + {C}_{i} ) + {λ}_{2} {E}_{i} ] \times {1}_{\{ {B}_{i} - k {μ}_{i} > {B}_{0}^{p} \}} .$$

The third energy routing 826 may be optimal in terms of link quality and path energy consumption with buffer availability at the next link.

FIG. 9A illustrates a flow chart of an example of a method 900 for wireless communication at a relay node, such as the UE 104 or the base station 102. In an example, a base station 102 or a UE 104 can perform the functions described in method 900 using one or more of the components and techniques described in FIGS. 1, 3-5, and 10, such as via execution of one or more processors, individually or in combination.

At block 902, the method 800 may identify a current energy usage and an additional energy usage associated with a forwarding link with a peer node, where the additional energy usage is further associated with traffic information. In an aspect, the communicating component 342, e.g., in conjunction with processor(s) 312, memory 316, and/or transceiver 302, may be configured to identify a current energy usage and an additional energy usage associated with a forwarding link with a peer node, where the additional energy usage is further associated with traffic information. Thus, the UE 104, the processor(s) 312, the communicating component 342, or one of its subcomponents may define the means for identifying a current energy usage and an additional energy usage associated with a forwarding link with a peer node, where the additional energy usage is further associated with traffic information.

In an aspect, the communication module 342, working alongside processor(s) 312, memory 316, and transceiver 302, can be configured to assess both the current energy consumption and any supplementary energy expenditure linked to a forwarding link with a peer node. This supplementary energy usage may be tied to specific traffic data, which may include parameters such as traffic volume, priority, and transmission frequency. By evaluating these energy metrics, the system can optimize routing decisions, ensuring efficient energy management while maintaining robust communication pathways between nodes. This capability may be useful for enhancing network performance, particularly in scenarios where energy efficiency is important, such as in multi-hop sidelink relaying.

At block 904, the method 800 may transmit, to one of the peer node or another node, an indication including one or both of the current energy usage and the additional energy usage for energy aware traffic routing. In an aspect, the communicating component 342, e.g., in conjunction with processor(s) 312, memory 316, and/or transceiver 302, may be configured to transmit, to one of the peer node or another node, an indication including one or both of the current energy usage and the additional energy usage for energy aware traffic routing. Thus, the UE 104, the processor(s) 312, the communicating component 342, or one of its subcomponents may define the means for transmitting, to one of the peer node or another node, an indication including one or both of the current energy usage and the additional energy usage for energy aware traffic routing.

In an aspect, the communication module 342, which may be integrated with processor(s) 312, memory 316, and transceiver 302, can be configured to send a signal to either a peer node or another network node. This signal may convey information about the current energy consumption and any extra energy expenditure associated with traffic routing decisions. By providing these energy usage metrics, the system facilitates energy-aware routing, allowing nodes to make informed decisions that optimize energy efficiency while maintaining effective data transmission. This functionality may be essential for managing network resources in energy-sensitive environments, such as multi-hop sidelink relaying, where conserving energy is useful for prolonging device operation and enhancing overall network sustainability.

In some implementations, the traffic information may correspond to an energy cost list including one or more traffic classes for discovery based energy cost sharing. Further, in these implementations, each of the one or more traffic classes may indicate one or more traffic parameters corresponding to at least one of a jitter, a delay tolerance, a burst length, or a periodicity. Additionally, in these implementations, each of the one or more traffic parameters may correspond to a numerical value that indicates an additional energy cost associated with the forwarding link.

In other implementations, the traffic information may correspond to traffic information of a source node and includes a request for the additional energy usage. In these implementations, the traffic information of the source node may include one or more of an expected traffic rate, an expected packet size, a traffic burst duration, a traffic priority, or a traffic delay requirements.

In further implementations, the indication may be transmitted periodically or based on a change in one or both of the current energy usage or the additional energy usage from a previous current energy usage and a previous additional energy usage. In these implementations, the change in one or both of the current energy usage or the additional energy usage may be associated with an establishment, tear down or rerouting of traffic for one or more communication sessions. In these implementations, the change in one or both of the current energy usage or the additional energy usage may be associated with a change in a power savings parameter determined between the relay node and the peer node at one of a physical (PHY) or medium access control (MAC) layer.

In other implementations, one or both of the energy usage or the additional energy usage may be identified based on a discontinuous reception cycle (DRX) schedule or a power savings schedule. In these implementations, identifying the current energy usage and the additional energy usage may include identifying a second energy usage and a second additional usage based on a change in the DRX schedule or the power savings schedule.

In further implementations, identifying the current energy usage and the additional energy usage may include identifying a second energy usage and a second additional usage associated with a communication path to one or more destination nodes. Further, the method 900 may include transmitting the second energy usage and the second additional usage associated with the communication path to one or more destination nodes. In these implementations, the current energy usage and the additional energy usage may be aggregated along with the second energy usage and the second additional usage. In these implementations, the current energy usage and the additional energy usage may be assigned a weight value along with the second energy usage and the second additional usage.

In an implementation, method 900 may optionally include relaying information to the peer node in response to transmitting the indication including one or both of the current energy usage and the expected energy usage, receiving a feedback indication from the peer node based on a quality of the relayed information, and updating the current energy usage and an additional energy usage based at least in part on receiving the feedback indication.

FIG. 9B illustrates a flow chart of an example of a method 910 for wireless communication at a relay node, such as the base station 102 or the UE 104. In an example, a base station 102 or a UE 104 can perform the functions described in method 910 using one or more of the components and techniques described in FIGS. 1, 2-5, and 10, such as via execution of one or more processors, individually or in combination.

At block 912, the method 910 may identify buffer status information including a current buffer state and a future buffer state associated with a forwarding link with a peer node. In an aspect, the communicating component 342, e.g., in conjunction with processor(s) 312, memory 316, and/or transceiver 302, may be configured to identify buffer status information including a current buffer state and a future buffer state associated with a forwarding link with a peer node. Thus, the UE 104, the processor(s) 312, the communicating component 342, or one of its subcomponents may define the means for identifying buffer status information including a current buffer state and a future buffer state associated with a forwarding link with a peer node.

In an aspect, the communication module 342, in conjunction with processor(s) 312, memory 316, and transceiver 302, can be configured to assess buffer status details. This may include determining both the present buffer condition and predicting future buffer states related to a forwarding link with a peer node. By analyzing these buffer metrics, the system can optimize data flow management, ensuring efficient handling of network traffic and preventing congestion or data loss. This capability may be useful for maintaining high-performance communication, particularly in dynamic network environments where real-time adjustments to buffer allocations are important to accommodate varying traffic loads and ensure seamless connectivity.

At block 914, the method 910 may transmit, to one of the peer node or another node, an indication including one or both of the current buffer state and the future buffer state for energy aware traffic routing. In an aspect, the communicating component 342, e.g., in conjunction with processor(s) 312, memory 316, and/or transceiver 302, may be configured to transmit, to one of the peer node or another node, an indication including one or both of the current buffer state and the future buffer state for energy aware traffic routing. Thus, the UE 104, the processor(s) 312, the communicating component 342, or one of its subcomponents may define the means for transmitting, to one of the peer node or another node, an indication including one or both of the current buffer state and the future buffer state for energy aware traffic routing.

In an aspect, the communication module 342, which may be integrated with processor(s) 312, memory 316, and transceiver 302, can be configured to send a notification to either a peer node or another network node. This notification may include information about the current buffer status and potentially the anticipated future buffer status, which may be useful for energy-aware traffic routing. By providing these buffer state metrics, the system may enable relay nodes to make informed routing decisions that optimize energy efficiency while effectively managing data flow. This functionality may be useful for maintaining network performance, particularly in environments where energy conservation is critical, such as in multi-hop relaying. It ensures that traffic may be routed in a manner that minimizes energy consumption while preventing buffer overflow or congestion, thereby enhancing overall network sustainability and reliability.

In one implementation, identifying the current status information may include identifying a forward link service rate representing a data transmission rate between the relay node and the peer node or the other node.

In another implementation, the future buffer state may correspond to a list of future buffer statuses such that each buffer status is associated with an estimated energy cost. In such implementation, the energy cost may be one of a numerical value or an unbound quantity represented by a symbol.

In another implementation, the buffer status information may further include a maximum bit rate indication.

In a further implementation, the estimated energy cost may be associated with an increased service rate for buffer overflow or bloating prevention.

FIG. 10 is a block diagram of a MIMO communication system 1000 including a base station 102, which may be acting as a network entity, and a UE 104. The MIMO communication system 1000 may illustrate aspects of the wireless communication access network 100 described with reference to FIG. 1. The base station 102 may be an example of aspects of the base station 102 described with reference to FIG. 1. The base station 102 may be equipped with antennas 1034 and 1035, and the UE 104 may be equipped with antennas 1052 and 1053. In the MIMO communication system 1000, the base station 102 may be able to send data over multiple communication links at the same time. Each communication link may be called a “layer” and the “rank” of the communication link may indicate the number of layers used for communication. For example, in a 2×2 MIMO communication system where base station 102 transmits two “layers,” the rank of the communication link between the base station 102 and the UE 104 is two.

At the base station 102, a transmit (Tx) processor 1020 may receive data from a data source. The transmit processor 1020 may process the data. The transmit processor 1020 may also generate control symbols or reference symbols. A transmit MIMO processor 1030 may perform spatial processing (e.g., precoding) on data symbols, control symbols, or reference symbols, if applicable, and may provide output symbol streams to the transmit modulator/demodulators 1032 and 1033. Each modulator/demodulator 1032 through 1033 may process a respective output symbol stream (e.g., for OFDM, etc.) to obtain an output sample stream. Each modulator/demodulator 1032 through 1033 may further process (e.g., convert to analog, amplify, filter, and upconvert) the output sample stream to obtain a DL signal. In one example, DL signals from modulator/demodulators 1032 and 1033 may be transmitted via the antennas 1034 and 1035, respectively.

The UE 104 may be an example of aspects of the UEs 104 described with reference to FIGS. 1 and 2. At the UE 104, the UE antennas 1052 and 1053 may receive the DL signals from the base station 102 and may provide the received signals to the modulator/demodulators 1054 and 1055, respectively. Each modulator/demodulator 1054 through 1055 may condition (e.g., filter, amplify, downconvert, and digitize) a respective received signal to obtain input samples. Each modulator/demodulator 1054 through 1055 may further process the input samples (e.g., for OFDM, etc.) to obtain received symbols. A MIMO detector 1056 may obtain received symbols from the modulator/demodulators 1054 and 1055, perform MIMO detection on the received symbols, if applicable, and provide detected symbols. A receive (Rx) processor 1058 may process (e.g., demodulate, deinterleave, and decode) the detected symbols, providing decoded data for the UE 104 to a data output, and provide decoded control information to a processor 1080, or memory 1082.

The processor 1080 may in some cases execute stored instructions to instantiate the communicating component 242 (see e.g., FIGS. 1 and 2) for distributed relaying that optimizes system energy while performing flow control.

On the uplink (UL), at the UE 104, a transmit processor 1064 may receive and process data from a data source. The transmit processor 1064 may also generate reference symbols for a reference signal. The symbols from the transmit processor 1064 may be precoded by a transmit MIMO processor 1066 if applicable, further processed by the modulator/demodulators 1054 and 1055 (e.g., for SC-FDMA, etc.), and be transmitted to the base station 102 in accordance with the communication parameters received from the base station 102. At the base station 102, the UL signals from the UE 104 may be received by the antennas 1034 and 1035, processed by the modulator/demodulators 1032 and 1033, detected by a MIMO detector 1036 if applicable, and further processed by a receive processor 1038. The receive processor 1038 may provide decoded data to a data output and to the processor 1040 or memory 1042.

The processor 1040 may in some cases execute stored instructions to instantiate the communicating component 342 (see e.g., FIGS. 1 and 3) for distributed relaying that optimizes system energy while performing flow control.

The components of the UE 104 may, individually or collectively, be implemented with one or more ASICs adapted to perform some or all of the applicable functions in hardware. Each of the noted modules may be a means for performing one or more functions related to operation of the MIMO communication system 1000. Similarly, the components of the base station 102 may, individually or collectively, be implemented with one or more ASICs adapted to perform some or all of the applicable functions in hardware. Each of the noted components may be a means for performing one or more functions related to operation of the MIMO communication system 1000.

### Some Additional Examples

The aspects described herein additionally include one or more of the following aspect examples described in the following numbered clauses.

A relay node for wireless communications, comprising:
a transceiver having a plurality of antennas;
one or more memories; and
one or more processors coupled to at least one of the one or more memories and configured to:
   identifying a current energy usage and an additional energy usage associated with a forwarding link with a peer node, wherein the additional energy usage is further associated with traffic information; and
   transmitting, to one of the peer node or another node, an indication including one or both of the current energy usage and the additional energy usage for energy aware traffic routing.

2. The relay node of clause 1, wherein the traffic information corresponds to an energy cost list including one or more traffic classes for discovery based energy cost sharing.

3. The relay node of clause 2, wherein each of the one or more traffic classes indicates one or more traffic parameters corresponding to at least one of a jitter, a delay tolerance, a burst length, or a periodicity.

4. The relay node of clause 3, wherein each of the one or more traffic parameters corresponds to a numerical value that indicates an additional energy cost associated with the forwarding link.

5. The relay node of clauses 1-4, wherein the traffic information corresponds to traffic information of a source node and includes a request for the additional energy usage.

6. The relay node of clause 5, wherein the traffic information of the source node includes one or more of an expected traffic rate, an expected packet size, a traffic burst duration, a traffic priority, or a traffic delay requirements.

7. The relay node of clauses 1-6, wherein the indication is transmitted periodically or based on a change in one or both of the current energy usage or the additional energy usage from a previous current energy usage and a previous additional energy usage.

8. The relay node of clause 7, wherein the change in one or both of the current energy usage or the additional energy usage is associated with an establishment, tear down or rerouting of traffic for one or more communication sessions.

9. The relay node of clause 7, wherein the change in one or both of the current energy usage or the additional energy usage is associated with a change in a power savings parameter determined between the relay node and the peer node at one of a physical (PHY) or medium access control (MAC) layer.

10. The relay node of clauses 1-9, wherein one or both of the energy usage or the additional energy usage is identified based on a discontinuous reception cycle (DRX) schedule or a power savings schedule.

11. The relay node of clause 10, wherein to identify the current energy usage and the additional energy usage, the one or more processors are further configured to identify a second energy usage and a second additional usage based on a change in the DRX schedule or the power savings schedule.

12. The relay node of clauses 1-11, wherein to identify the current energy usage and the additional energy usage, the one or more processors are further configured to identify a second energy usage and a second additional usage associated with a communication path to one or more destination nodes, the one or more processors are further configured to:
transmit the second energy usage and the second additional usage associated with the communication path to one or more destination nodes.

13. The relay node of clause 12, wherein the current energy usage and the additional energy usage are aggregated along with the second energy usage and the second additional usage.

14. The relay node of clause 12, wherein the current energy usage and the additional energy usage are assigned a weight value along with the second energy usage and the second additional usage.

15. A relay node for wireless communications, comprising:
a transceiver having a plurality of antennas;
one or more memories; and
one or more processors coupled to at least one of the one or more memories and configured to:
   identify buffer status information including a current buffer state and a future buffer state associated with a forwarding link with a peer node; and
   transmit, to one of the peer node or another node, an indication including one or both of the current buffer state and the future buffer state for energy aware traffic routing.

16. The relay node of clause 15, wherein to identify the current status information, the one or more processors are further configured to identify a forward link service rate representing a data transmission rate between the relay node and the peer node or the other node.

17. The relay node of clauses 15 and 16, wherein the future buffer state corresponds to a list of future buffer statuses such that each buffer status is associated with an estimated energy cost.

18. The relay node of clause 17, wherein the energy cost is one of a numerical value or an unbound quantity represented by a symbol.

19. The relay node of clauses 15-18, wherein the buffer status information further includes a maximum bit rate indication.

20. A method for wireless communications, comprising:
identifying a current energy usage and an additional energy usage associated with a forwarding link with a peer node, wherein the additional energy usage is further associated with traffic information; and
transmitting, to one of the peer node or another node, an indication including one or both of the current energy usage and the additional energy usage for energy aware traffic routing.

The above detailed description set forth above in connection with the appended drawings describes examples and does not represent the only examples that may be implemented or that are within the scope of the claims. The term “example,” when used in this description, means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and apparatuses are shown in block diagram form in order to avoid obscuring the concepts of the described examples.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, computer-executable code or instructions stored on a computer-readable medium, or any combination thereof.

The various illustrative blocks and components described in connection with the disclosure herein may be implemented or performed with a specially-programmed device, such as but not limited to a processor, a digital signal processor (DSP), an ASIC, a FPGA or other programmable logic device, a discrete gate or transistor logic, a discrete hardware component, or any combination thereof designed to perform the functions described herein. A specially-programmed processor may be a microprocessor, but in the alternative, the processor may be any conventional processor, controller, microcontroller, or state machine. A specially-programmed processor may also be implemented as a combination of computing devices, e.g., a combination of a DSP and a microprocessor, multiple microprocessors, one or more microprocessors in conjunction with a DSP core, or any other such configuration.

As used herein, a processor, at least one processor, and/or one or more processors, individually or in combination, configured to perform or operable for performing a plurality of actions is meant to include at least two different processors able to perform different, overlapping or non-overlapping subsets of the plurality actions, or a single processor able to perform all of the plurality of actions. In one non-limiting example of multiple processors being able to perform different ones of the plurality of actions in combination, a description of a processor, at least one processor, and/or one or more processors configured or operable to perform actions X, Y, and Z may include at least a first processor configured or operable to perform a first subset of X, Y, and Z (e.g., to perform X) and at least a second processor configured or operable to perform a second subset of X, Y, and Z (e.g., to perform Y and Z). Alternatively, a first processor, a second processor, and a third processor may be respectively configured or operable to perform a respective one of actions X, Y, and Z. It should be understood that any combination of one or more processors each may be configured or operable to perform any one or any combination of a plurality of actions.

The functions described herein may be implemented in hardware, software, or any combination thereof. If implemented in software executed by a processor, the functions may be stored on or transmitted over as one or more instructions or code on a non-transitory computer-readable medium. Other examples and implementations are within the scope and spirit of the disclosure and appended claims. For example, due to the nature of software, functions described above can be implemented using software executed by a specially programmed processor, hardware, hardwiring, or combinations of any of these. Features implementing functions may also be physically located at various positions, including being distributed such that portions of functions are implemented at different physical locations. Moreover, the term “or” is intended to mean an inclusive “or” rather than an exclusive “or.” That is, unless specified otherwise, or clear from the context, the phrase, for example, “X employs A or B” is intended to mean any of the natural inclusive permutations. That is, for example the phrase “X employs A or B” is satisfied by any of the following instances: X employs A; X employs B; or X employs both A and B. Also, as used herein, including in the claims, “or” as used in a list of items prefaced by “at least one of” indicates a disjunctive list such that, for example, a list of “at least one of A, B, or C” means A or B or C or AB or AC or BC or ABC (A and B and C).

Computer-readable media includes both computer storage media and communication media including any medium that facilitates transfer of a computer program from one place to another. A storage medium may be any available medium that can be accessed by a general purpose or special purpose computer. By way of example, and not limitation, computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, a memory, at least one memory, and/or one or more memories, individually or in combination, configured to store or having stored thereon instructions executable by one or more processors for performing a plurality of actions is meant to include at least two different memories able to store different, overlapping or non-overlapping subsets of the instructions for performing different, overlapping or non-overlapping subsets of the plurality actions, or a single memory able to store the instructions for performing all of the plurality of actions. In one non-limiting example of one or more memories, individually or in combination, being able to store different subsets of the instructions for performing different ones of the plurality of actions, a description of a memory, at least one memory, and/or one or more memories configured or operable to store or having stored thereon instructions for performing actions X, Y, and Z may include at least a first memory configured or operable to store or having stored thereon a first subset of instructions for performing a first subset of X, Y, and Z (e.g., instructions to perform X) and at least a second memory configured or operable to store or having stored thereon a second subset of instructions for performing a second subset of X, Y, and Z (e.g., instructions to perform Y and Z). Alternatively, a first memory, and second memory, and a third memory may be respectively configured to store or have stored thereon a respective one of a first subset of instructions for performing X, a second subset of instruction for performing Y, and a third subset of instructions for performing Z. It should be understood that any combination of one or more memories each may be configured or operable to store or have stored thereon any one or any combination of instructions executable by one or more processors to perform any one or any combination of a plurality of actions. Moreover, one or more processors may each be coupled to at least one of the one or more memories and configured or operable to execute the instructions to perform the plurality of actions. For instance, in the above non-limiting example of the different subset of instructions for performing actions X, Y, and Z, a first processor may be coupled to a first memory storing instructions for performing action X, and at least a second processor may be coupled to at least a second memory storing instructions for performing actions Y and Z, and the first processor and the second processor may, in combination, execute the respective subset of instructions to accomplish performing actions X, Y, and Z. Alternatively, three processors may access one of three different memories each storing one of instructions for performing X, Y, or Z, and the three processor may in combination execute the respective subset of instruction to accomplish performing actions X, Y, and Z. Alternatively, a single processor may execute the instructions stored on a single memory, or distributed across multiple memories, to accomplish performing actions X, Y, and Z.

The previous description of the disclosure is provided to enable a person skilled in the art to make or use the disclosure. Various modifications to the disclosure will be readily apparent to those skilled in the art, and the common principles defined herein may be applied to other variations without departing from the spirit or scope of the disclosure. Furthermore, although elements of the described aspects and/or embodiments may be described or claimed in the singular, the plural is contemplated unless limitation to the singular is explicitly stated. Additionally, all or a portion of any aspect and/or embodiment may be utilized with all or a portion of any other aspect and/or embodiment, unless stated otherwise. Thus, the disclosure is not to be limited to the examples and designs described herein but is to be accorded the widest scope consistent with the principles and novel features disclosed herein.

What is claimed is:

1. A relay node for wireless communications, comprising:
a transceiver having a plurality of antennas;
one or more memories; and
one or more processors coupled to at least one of the one or more memories and configured to:
identifying a current energy usage and an additional energy usage associated with a forwarding link with a peer node, wherein the additional energy usage is further associated with traffic information; and
transmitting, to one of the peer node or another node, an indication including one or both of the current energy usage and the additional energy usage for energy aware traffic routing.

2. The relay node of claim 1, wherein the traffic information corresponds to an energy cost list including one or more traffic classes for discovery based energy cost sharing.

3. The relay node of claim 2, wherein each of the one or more traffic classes indicates one or more traffic parameters corresponding to at least one of a jitter, a delay tolerance, a burst length, or a periodicity.

4. The relay node of claim 3, wherein each of the one or more traffic parameters corresponds to a numerical value that indicates an additional energy cost associated with the forwarding link.

5. The relay node of claim 1, wherein the traffic information corresponds to traffic information of a source node and includes a request for the additional energy usage.

6. The relay node of claim 5, wherein the traffic information of the source node includes one or more of an expected traffic rate, an expected packet size, a traffic burst duration, a traffic priority, or a traffic delay requirements.

7. The relay node of claim 1, wherein the indication is transmitted periodically or based on a change in one or both of the current energy usage or the additional energy usage from a previous current energy usage and a previous additional energy usage.

8. The relay node of claim 7, wherein the change in one or both of the current energy usage or the additional energy usage is associated with an establishment, tear down or rerouting of traffic for one or more communication sessions.

9. The relay node of claim 7, wherein the change in one or both of the current energy usage or the additional energy usage is associated with a change in a power savings parameter determined between the relay node and the peer node at one of a physical (PHY) or medium access control (MAC) layer.

10. The relay node of claim 1, wherein one or both of the energy usage or the additional energy usage is identified based on a discontinuous reception cycle (DRX) schedule or a power savings schedule.

11. The relay node of claim 10, wherein to identify the current energy usage and the additional energy usage, the one or more processors are further configured to identify a second energy usage and a second additional usage based on a change in the DRX schedule or the power savings schedule.

12. The relay node of claim 1, wherein to identify the current energy usage and the additional energy usage, the one or more processors are further configured to identify a second energy usage and a second additional usage associated with a communication path to one or more destination nodes, the one or more processors are further configured to:
transmit the second energy usage and the second additional usage associated with the communication path to one or more destination nodes.

13. The relay node of claim 12, wherein the current energy usage and the additional energy usage are aggregated along with the second energy usage and the second additional usage.

14. The relay node of claim 12, wherein the current energy usage and the additional energy usage are assigned a weight value along with the second energy usage and the second additional usage.

15. A relay node for wireless communications, comprising:
a transceiver having a plurality of antennas;
one or more memories; and
one or more processors coupled to at least one of the one or more memories and configured to:
identify buffer status information including a current buffer state and a future buffer state associated with a forwarding link with a peer node; and
transmit, to one of the peer node or another node, an indication including one or both of the current buffer state and the future buffer state for energy aware traffic routing.

16. The relay node of claim 15, wherein to identify the current status information, the one or more processors are further configured to identify a forward link service rate representing a data transmission rate between the relay node and the peer node or the other node.

17. The relay node of claim 15, wherein the future buffer state corresponds to a list of future buffer statuses such that each buffer status is associated with an estimated energy cost.

18. The relay node of claim 17, wherein the energy cost is one of a numerical value or an unbound quantity represented by a symbol.

19. The relay node of claim 15, wherein the buffer status information further includes a maximum bit rate indication.

20. A method for wireless communications, comprising:
identifying a current energy usage and an additional energy usage associated with a forwarding link with a peer node, wherein the additional energy usage is further associated with traffic information; and
transmitting, to one of the peer node or another node, an indication including one or both of the current energy usage and the additional energy usage for energy aware traffic routing.
